(19) United States
(12) Patent Application Publication
(10) Pub. No.: US 2011/0197930 A1
(43) Pub. Date: Aug. 18, 2011

(54) SPRAY BULB CLEANER FOR DIGITAL CAMERA SENSORS

(76) Inventor: Fariborz Rahbar-Dehghan, Canmore (CA)

(21) Appl. No.: 13/126,819

(22) PCT Filed: Oct. 29, 2009
(86) PCT No.: PCT/CA09/01571

§ 371 Date: Apr. 29, 2011

Related U.S. Application Data
(60) Provisional application No. 61/198,851, filed on Nov. 10, 2008.

(51) Int. Cl. B08B 7/00

(52) U.S. Cl. 134/34; 15/405

(57) ABSTRACT

A spray bulb cleaner is provided for removing dust from digital camera sensors. The cleaner comprises a compressible yet resilient manually actuatable bulb body defining a deformable wall circumscribing an air enclosure. The bulb wall has an air outlet enabling air outflow from the bulb air enclosure toward ambient air when the bulb is squeezed and becomes deformed. The bulb wall also has an air intake enabling ambient air inflow into the bulb air enclosure. A releasable first one-way valve mounted at the air intake, controls air inflow from ambient air towards the bulb enclosure. A releasable second one-way valve mounted at a tubular nozzle inner end portion controls air outflow from the bulb air enclosure toward ambient air. The nozzle is mounted at to the bulb air outlet. At least a portion of the spray bulb is made from an electrostatically charged ionizing compound for neutralizing a target surface to be dusted by the spray bulb cleaner. A filter member can be mounted adjacent either the first or second one-way valves.

### CROSS-REFERENCE DATA

The present application claims Paris convention priority based upon U.S. provisional patent application No. 61/198,851 filed Nov. 10, 2008.

### BACKGROUND OF THE INVENTION

A spray bottle is a bottle that can squirt, spray or mist fluids. A common use for spray bottles is dispensing cool cleaners, cosmetics, and chemical specialties. Another wide use of spray bottles is mixing down concentrates such as pine oil with water.

On the other hand, a spray bulb will simply spray air over a target surface to be cleaned. Spray bottles and spray bulbs can be used with a rubber bulb, which is squeezed to expel air through an air outlet.

A problem with spray bulbs for use in air cleaning of delicate surface targets is that the air intake coincides with the air outlet thereof. Accordingly, if dust is removed from the surface target by the air outflow from the spray bulb, there is a risk that this dislodged airborne dust close to the spray bulb combined air outlet/air intake will be captured by the air suction of the spray bulb once air outflow from the spray bulb is completed and the rubber bulb is allowed to return under spring back action to its original un-deformed condition. In other words, the dust removed from the exterior target surface is sucked into the enclosure of the rubber bulb body, and then expelled with the next squeeze sequence of the spray bulb, thus potentially contaminating with the previously removed dust the next target surface to be cleaned.

### SUMMARY OF THE INVENTION

The invention relates to a spray bulb cleaner for removing dust from a target surface comprising: a flexible manually actuatable bulb body defining a deformable yet resilient arcuate wall having spring-back capability and circumscribing a generally closed air enclosure, said bulb body wall having air outlet means, enabling air outflow from said bulb air enclosure toward ambient air, and air intake means, enabling ambient air inflow into said bulb body air enclosure; a releasable first one-way valve, mounted at said air intake means and controlling air inflow from ambient air into said bulb body air enclosure, and a releasable second one-way valve, mounted at said air outlet means and controlling air outflow from said bulb body air enclosure toward ambient air.

Preferably, a tubular nozzle is provided, being fluidingly mounted at an inner end portion thereof to said bulb air outlet means and defining air outflow mouth at an outer end portion opposite said inner end portion thereof, said air outflow mouth being the diametrally smallest section of said nozzle.

At least part of said spray bulb could be made from an electro-statically charged ionizing compound.

The spray bulb could also be in combination with a pad for removing dust from a target surface, said pad being made from an electro-statically charged ionizing compound.

The invention also relates to the use of an ionizing compound in a spray bulb as in claim 1, for neutralizing a target surface to be dusted.

Preferably, a first air filter member is mounted into said bulb air intake means adjacent said first one way valve. A second air filter member could then be mounted into said tubular nozzle inner end portion adjacent said second one way valve.

Preferably, said air outlet means and said air intake means are coaxially aligned on opposite sides of said bulb body.

The invention also relates to a. method of use of a spray bulb cleaner on a digital camera sensor, said spray bulb being of the type comprising: a flexible manually actuatable bulb body defining a deformable yet resilient arcuate wall having spring back capability and circumscribing a generally closed air enclosure, said bulb body wall having an air outlet means, enabling air outflow from said bulb air enclosure toward ambient air, and an air intake, enabling ambient air inflow into said bulb air enclosure; a releasable first one-way valve, mounted at said air intake means, controlling air inflow from ambient air towards said bulb air enclosure; and a releasable second one-way valve mounted at said tubular nozzle inner end portion controlling air outflow from said bulb air enclosure toward ambient air; wherein said method comprising the following steps: a) squeezing said bulb body wall to deform same from an original larger air volume to a reduced air volume of said bulb air enclosure; b) expelling air from said air enclosure through said air outlet means, c) directing said expelled air toward the camera sensor to be cleaned;

d) releasing the bulb body wall; e) allowing ambiant air to enter into said bulb air enclosure through said air intake means until said original larger air volume inside wais bulb air enclosure is substantially reached under resilient spring back action of said bulb body wall.

An additional step envisioned could include: further comprising the step of providing an elongated nozzle mounted at an inner end portion thereof at said air outlet means, and having an outer end mouth at an outer end portion thereof, said elongated nozzle enabling optimal directional air expulsion from said bulb air enclosure for cleaning a target surface. A first air filter means could be mounted into said air intake means as an additional step. A second air filter means could also be mounted into said nozzle as an additional step.

### BRIEF DESCRIPTION OF THE DRAWINGS

In the annexed drawings :

FIGS. 1 and 2 are a perspective view and a sectional view respectively of a spray bulb cleaner according to the prior art;

FIGS. 3 and 4 are exploded views from two different perspectives of a preferred embodiment of spray bulb cleaner according to the present invention;

FIG. 4a is a perspective view of the air intake means one way valve of FIG. 4, shown in its opened condition;

FIG. 5 is a view similar to fig lb but for the embodiment of FIGS. 3-4 showing an enlarged cross-sectional side elevation of the nozzle of the spray bulb cleaner of FIGS. 3-4;

FIG. 6 is an enlarged sectional view of the nozzle of FIG. 5;

FIGS. 7 and 8 are elevational perspective views from two different points of view of a cleaning tool for use in combination with the spray bulb cleaner of FIGS. 3-5 according to the present invention; and

FIG. 9 is a perspective view of the cleaning tool of FIGS. 7-8 installed on a spinning device for removing dust collected on the spray bulb cleaner of FIGS. 3-5.

### DETAILED DESCRIPTION OF THE EMBODIMENTS

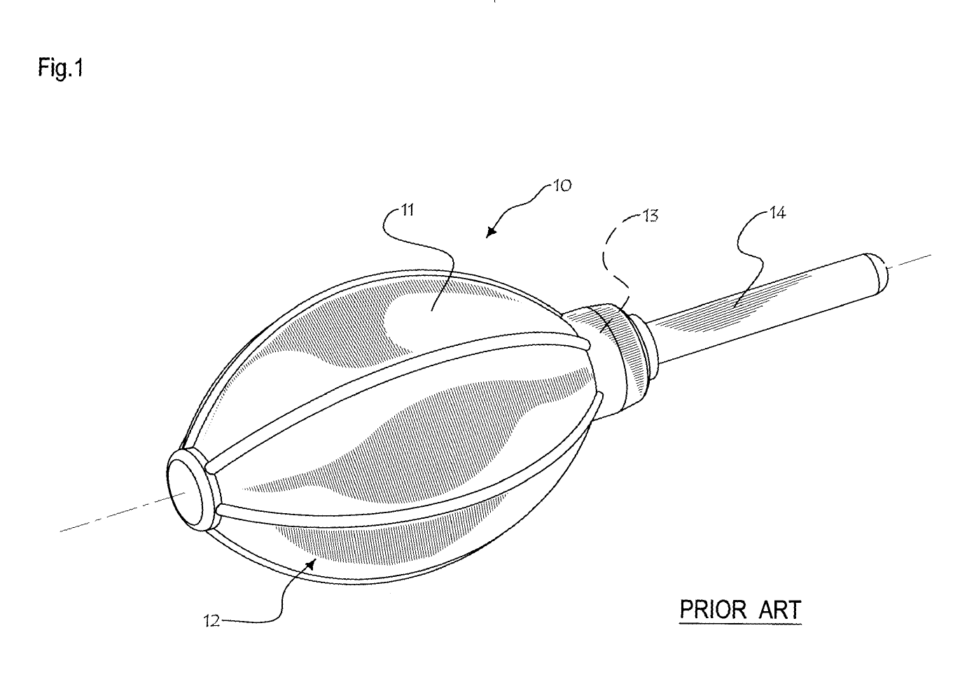

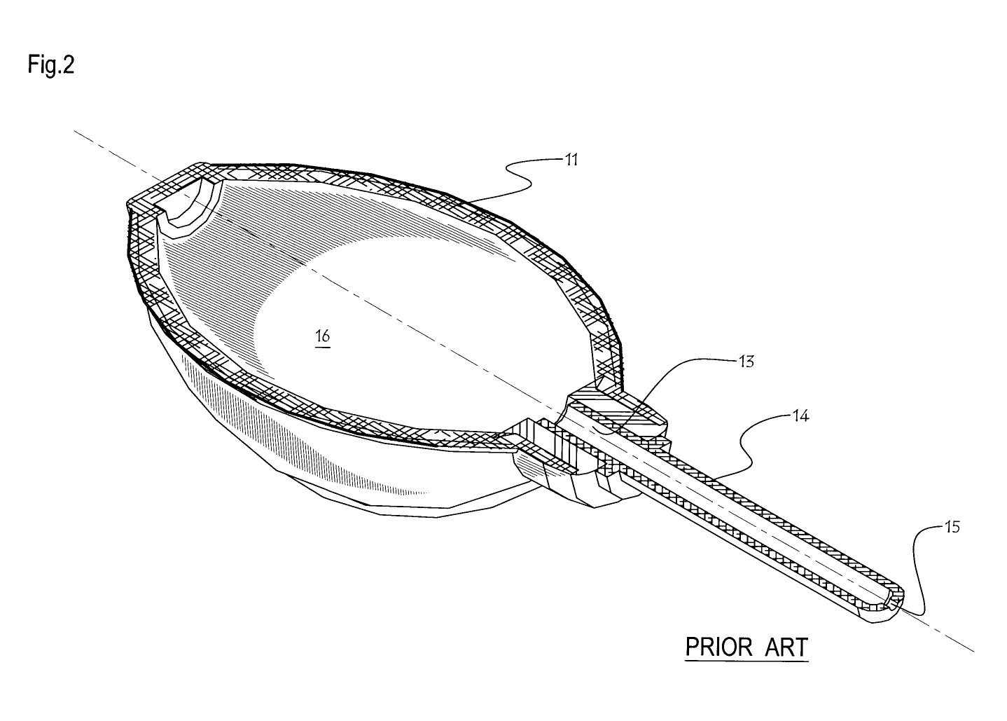

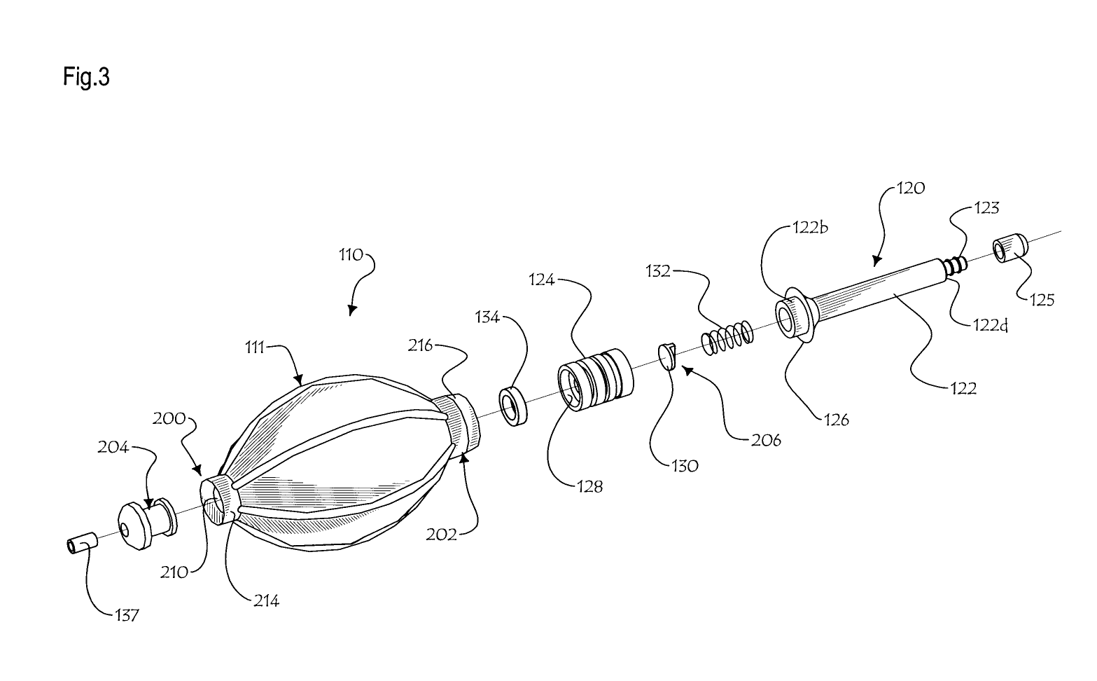

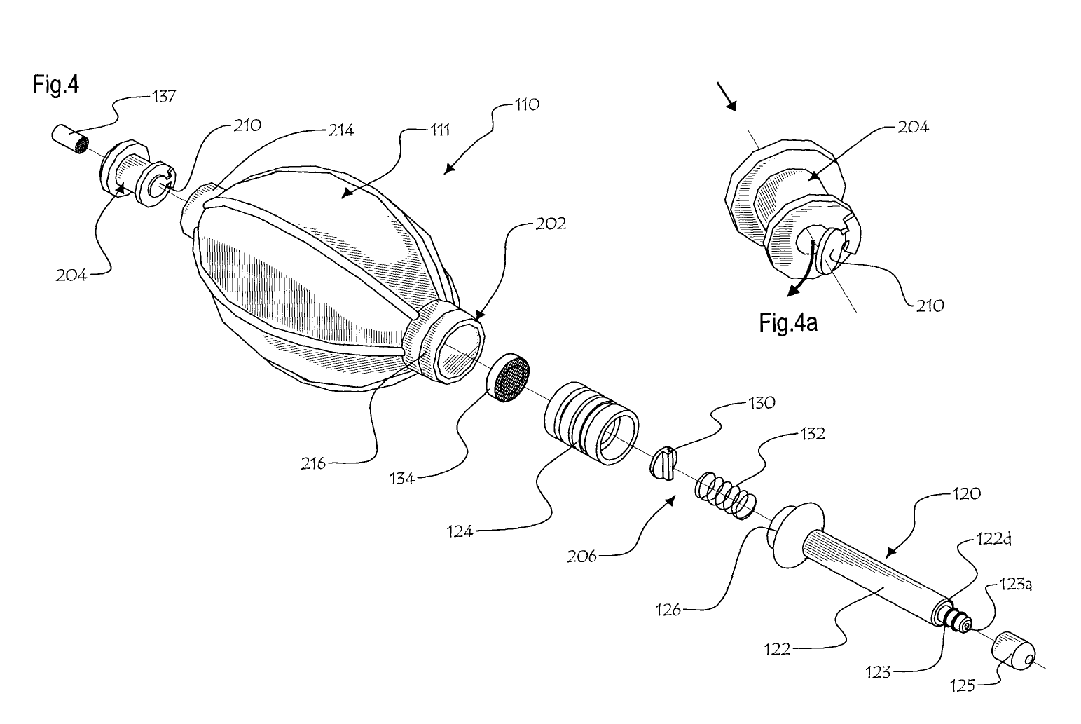

FIGS. 1 and 2 show a prior art spray bulb wherein the spray bulb is a manually operated dust blower which may be used to blow dust away from a target surface. This spray bulb 10 comprises a compressible hand-operated bulb body 12 made from a flexible compressible yet resilient material such as a suitable plastic or rubber material that allows the bulb to be squeezed to blow air out, and then released to return to its original shape by inherent spring back action, so as to suck air in as bulb body 12 regains its initial fully expanded pear-like shape. Bulb body 12 has a peripheral wall 11 defining a single mouth 13. A nozzle 14 is mounted at one end portion thereof into mouth 13. A generally closed inner chamber 16 is circumscribed within bulb body 11, with inner chamber 16 having a variable volume between an expanded full volume (shown in FIGS. 3-4) and a reduced volume occurring when the wall of bulb body 12 is deformed under compression. The outer end of nozzle 14 forms mouth 15.

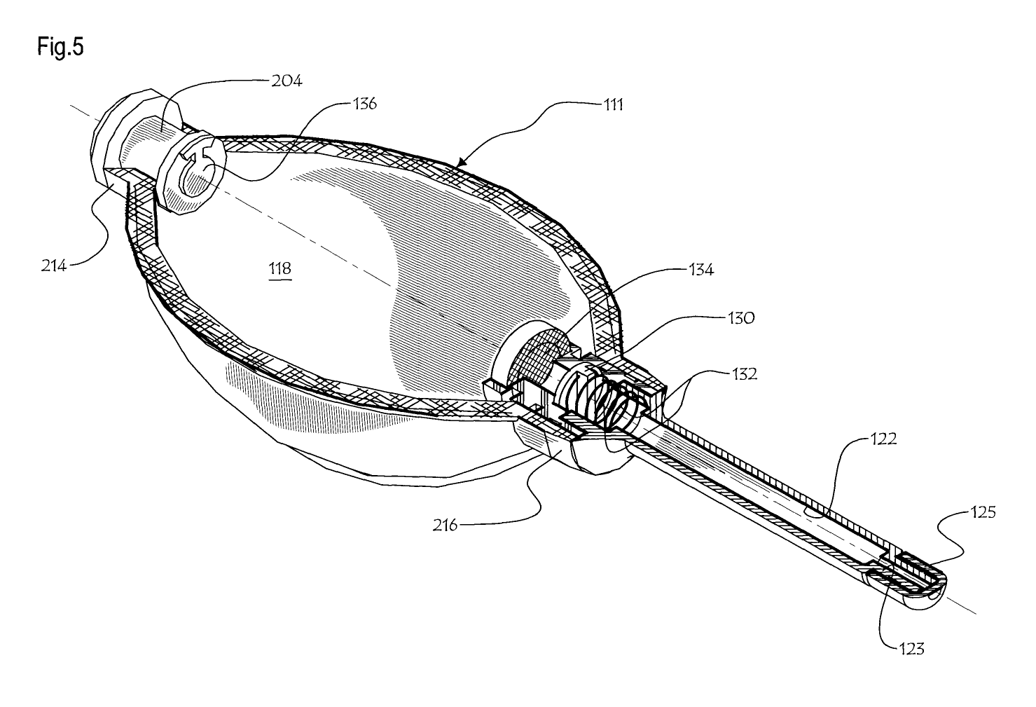

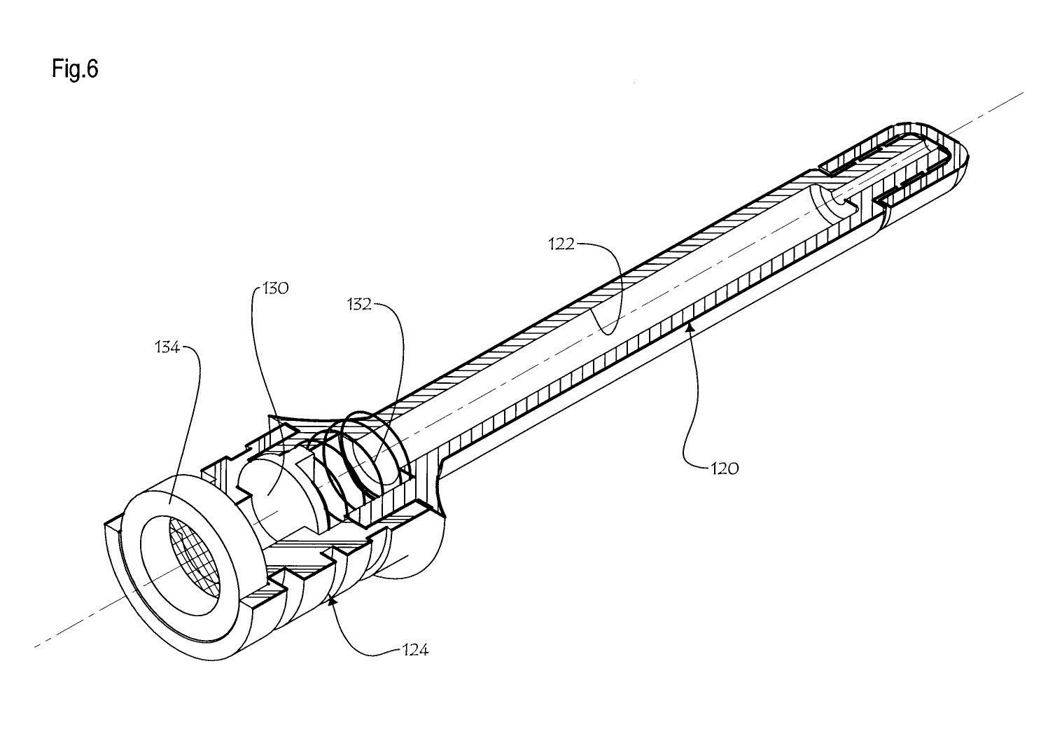

According to the preferred embodiment of invention illustrated in FIGS. 3 to 6, there is disclosed a spray bulb 110 comprising a bulb body 111 with air intake means 200 and air outlet means 202. Each air means 200 and 202 preferably forms a bore 210, 212, respectively each such bore being circumscribed by a radially outwardly extending tubular socket member 214, 216, respectively. As shown in FIG. 5, A first one way valve 204 is mounted into the radial tubular socket 214, while a second one way valve 206 is mounted into radial tubular socket 216.

A tubular nozzle 120 is further included, comprising a hollow pipe 122 having a threaded outer end nipple 123 and an inner end coupling portion 122b. Nipple 123 defines a diametrally smaller mouth 123a. A cap 125 threadingly releasably engages nipple 123 to releasably close mouth 123a when spray bulb 110 is not in use so as to minimize accidental contamination hazards. Coupling portion 122b is diametrically larger than main pipe 122, which is in turn diametrically larger than nipple 123. Coupling portion 122b is friction-fitted into and operatively engages a diametrally larger coaxial hollow tubular member 124. A radially extending peripheral pipe shoulder 126 is provided on coupling portion 122b on pipe 122 and axially releasably abuts against tubular member 124 and into tubular socket 216. Radial shoulder 126 is sized to be radially larger than socket 216.

Tubular member 124 is friction-fitted at its inner end portion into radial socket 216 and operatively engages into bore 212. Tubular member 124 comprises an inner shoulder 128.

Second one-way valve 206 includes a one-way backflow preventing valve gate 130 to be mounted into tubular member 124, against inner shoulder 128 where tubular member 124 is diametrically larger than valve gate 130. Valve gate 130 is movable between a closed position in which it rests against inner shoulder 128 and fluidingly seals the inner axial channel through tubular member 124; and an opened position in which valve gate 130 releases inner shoulder 128 and in which the coaxial channel through tubular member 124 and nozzle 120 becomes opened for free air flow. Valve gate 130 is continuously biased towards its closed position by means of a biasing member in the form of an elongated coil spring 132. Coil spring 132 is seated against the annular seat 122d formed by the diametrally narrowing rear end portion of pipe 122, inside pipe rear coupling portion 122, and abuts against valve gate 130.

An optional front filter means such as filter 134 may be installed within pipe mount 124 rearwardly of inner shoulder 128.

Rear valve means 204 engages radial socket 214 in the rear of bulb body 111. Preferably, mouths 210, 212 are coaxial, as illustrated. Rear one-way valve 204 allows air to be sucked into bulb body enclosure 118 but prevents air to be blown radially outwardly of bulb body 111 through rear opening 210. FIG. 4a shows gate 210 of valve 204 in opened condition. An optional rear filter means such as filter 137 could also be provided into one way valve 204.

Both the optional front and rear filters 134, 137, help minimizing dust particles contamination by substantially preventing dust from being first sucked into bulb body enclosure 118 and then blown out of spray bulb 110 through nozzle 122.

In use, spray bulb body 111 is manually squeezed to blow air out of inner chamber 118 through front socket mouth 212. The air inside inner chamber 118 will be expelled through nozzle 120 when bulb body 111 is squeezed. More particularly, the radially outwardly directed air pressure will force valve gate 130 towards its opened position against the bias of spring 132 to allow the air inside inner chamber 118 to flow around valve gate 130 and sequentially through the coextensive inner channels of tubular member 124 and pipe 122. Rear one-way valve 204 in turn prevents air from being blown out of bulb body 111 through rear mouth 210 when bulb body 111 is squeezed. Consequently, when a target surface (not shown) is being dusted, nozzle 120 is positioned near the target surface and bulb body 111 is squeezed and deformed to blow air out through nozzle 120 against the target surface, removing the dust from the target surface under the dynamic force of the expelled airflow.

Upon bulb body 111 being released, it will recover its original fully expanded shape under resilient spring back fashion; however, air will not be sucked into bulb body 11 through nozzle 120. Indeed, backflow preventing one-way valve 130 will prevent this. Air will be sucked in through rear opening 210 only, since gate 214 of rear valve 204 will yieldingly open to allow outside air inside bulb enclosure 118. This is desirable since the mouth 123a of nozzle 120 may still be located near the target surface where dust having been blown away from the target surface is now airborne. If air were to be sucked toward and into interior enclosure 118 of bulb body 111 from mouth 123a of nozzle 120, it might also suck in undesirable dust particles which might thereafter be stored temporarily into spray bulb enclosure 118 to be thereafter blown out onto that or another target surface in the next sequence of bulb body squeezing. This would be counterproductive, and yet, all known prior art dust blowers work this way. Accordingly, the present invention solves a long standing problem.

This combined action of front and rear one-way valves 204, 206, allows air to be blown out of bulb body 111 only through nozzle 120 and to be admitted into bulb body 111 only through rear mouth 210. This significantly helps prevent airborne dust particles from being undesirably accidentally sucked into bulb body 111 and/or nozzle 120 and temporarily stored therein and thereafter being blown out onto a target surface to be dusted.

It is understood that any other suitable conventional one-way valve allowing backflow prevention of air into bulb body 111 could be used instead of the illustrated valve gate 130 of valve means 206, described herein. Likewise, the rear one-way tubular valve 204 could be of any suitable conventional make.

According to one embodiment of the present invention, the material used to make at least some portions of spray bulb 110 is electro-statically charged. Indeed, it has been observed that dust and other indoor airborne particles often have a non-neutral electro-static charge, e.g. a positive charge. Also, many target surfaces are also electro-statically charged. This results in some target surfaces electrostatically attracting dust that will stick to the target surface. (One example of this being dust that sticks to computer or television screens.) By electro-statically charging, or ionizing, the spray bulb 110, the latter will transfer some ions to the air that circulates through it and that is blown out of it. This will help neutralize some airborne dust particles and some target surfaces to help prevent dust from being electro-statically attracted to target surfaces. Also, providing an electro-statically charged bulb body 111 contributes to attract some dust particles so that they stick to the bulb 112 peripheral wall inner surface, consequently preventing those dust particles from being undesirably ejected through front nozzle 120 when a target surface is being dusted.

According to an alternate embodiment, the material chosen to make most parts of spray bulb 110 will have a negative electro-static charge. The air that circulates through bulb body 111 and nozzle 120 will consequently carry negative ions that will at least partly neutralize positive target surfaces that it comes in contact with. Also, the negatively charged spray bulb 110 will contribute to partly neutralize positively charged airborne dust particles. The result being that dust will be less attracted to target surfaces on which spray bulb 110 has been used to blow dust away. Also, some positively charged airborne dust particles that have been accidentally sucked into bulb enclosure 118 will furthermore stick to the bulb peripheral wall inner surface, preventing those particles from being counter-productively ejected through nozzle 120 onto a target surface to be dusted.

One way to integrate this particular inventive feature is to make spray bulb 110 from an ionizing compound including a supporting matrix such as silicon to which an ionizing filler is added in a suitable proportion.

In one embodiment, the entire spray bulb 110 is made from an ionizing compound. According to an alternate embodiment, the ionizing compound is used to make a portion of spray bulb only, i.e. not all of it. For example, only bulb body 111 could be made from an ionizing compound.

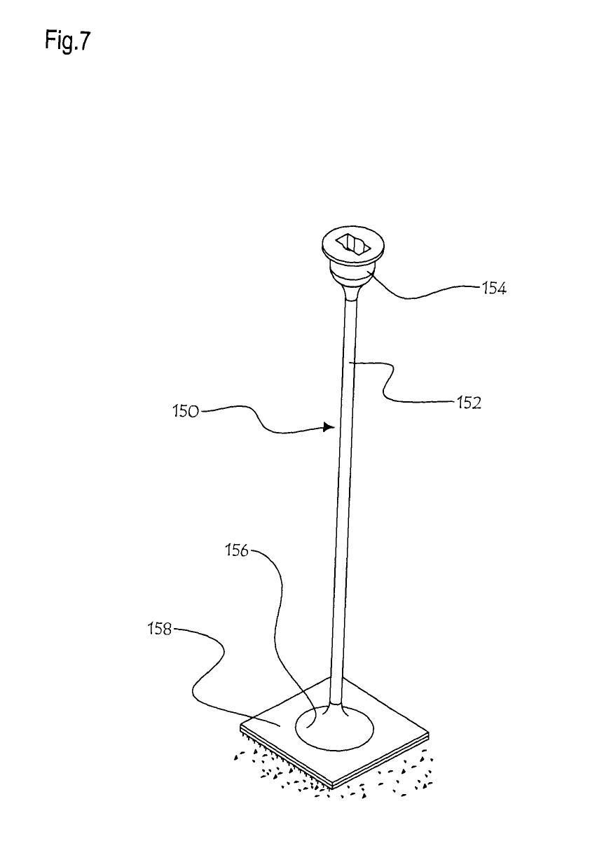

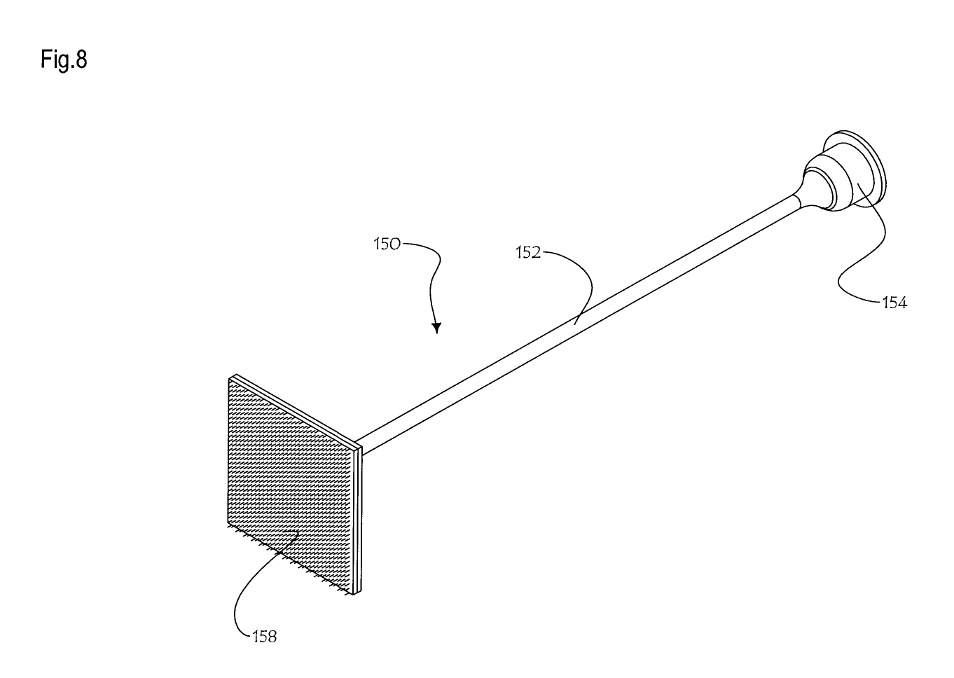

The present invention further provides for the use of an ionizing compound, in making a cleaning tool 150 according to another embodiment. More particularly, FIGS. 7 and 8 show that cleaning tool 150 comprises an elongated handle 152 having opposite upper and lower ends 154, 156. A dust-removing pad 158 made from an ionizing compound is attached to handle lower end 156.

In use, tool 150 is used to remove dust from a target surface by sliding pad 158 along that surface. By doing so, the positively charged dust particles will be attracted to the negatively charged ionizing pad 158 and be removed from the target surface. Furthermore, ionizing pad 158 will further contribute to electro-statically neutralize some target surfaces to help prevent them from attracting dust, by transferring negative ions to the target surfaces.

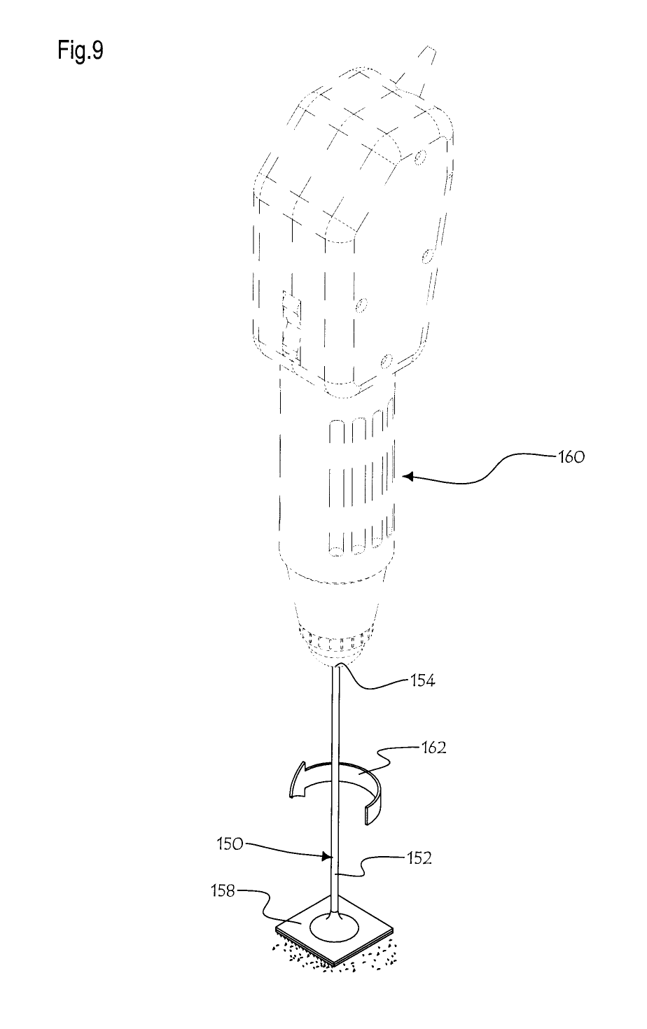

In one embodiment, the handle upper end 154 of cleaning tool 150 can be attached to a spinning device 160 (FIG. 9) that will rotate spray bulb 110 along direction 162 at high speed about the longitudinal axis of handle 152. Under the effect of the centrifugal force, dust on pad 158 will be removed therefrom. Spinning device 160 can consequently be used to remove dust from pad 158 between uses of pad 158 on target surfaces to be dusted.

Spray bulb 110 and cleaning tool 150 are particularly useful for use in dusting sensitive target surfaces such as digital camera sensors or the like where careful and thorough dust removal is very important. However, their use is in no way limited to these target surfaces.

I claim:

1. A spray bulb cleaner for removing dust from a target surface comprising:
a flexible manually actuatable bulb body defining a deformable yet resilient arcuate wall having spring-back capability and circumscribing a generally closed air enclosure, said bulb body wall having air outlet means, enabling air outflow from said bulb air enclosure toward ambient air, and air intake means, enabling ambient air inflow into said bulb body air enclosure;
a releasable first one-way valve, mounted at said air intake means and controlling air inflow from ambient air into said bulb body air enclosure, and
a releasable second one-way valve, mounted at said air outlet means and controlling air outflow from said bulb body air enclosure toward ambient air.

2. A spray bulb as in claim 1, further including a tubular nozzle, fluidingly mounted at an inner end portion thereof to said bulb air outlet means and defining air outflow mouth at an outer end portion opposite said inner end portion thereof, said air outflow mouth being the diametrally smallest section of said nozzle.

3. A spray bulb according to claim 1, wherein at least part of said spray bulb is made from an electro-statically charged ionizing compound.

4. A spray bulb as in claim 1, in combination with a pad for removing dust from a target surface, said pad being made from an electro-statically charged ionizing compound.

5. Use of an ionizing compound in a spray bulb as in claim 1, for neutralizing a target surface to be dusted.

6. A spray bulb as in claim 2, further including a first air filter member, mounted into said bulb air intake means adjacent said first one way valve.

7. A spray bulb as in claim 6, further including a second air filter member, mounted into said tubular nozzle inner end portion adjacent said second one way valve.

8. A spray bulb as in claim 7, wherein said air outlet means and said air intake means are coaxially aligned on opposite sides of said bulb body.

9. A method of use of a spray bulb cleaner on a digital camera sensor, said spray bulb being of the type comprising: a flexible manually actuatable bulb body defining a deformable yet resilient arcuate wall having spring back capability and circumscribing a generally closed air enclosure, said bulb body wall having an air outlet means, enabling air outflow from said bulb air enclosure toward ambient air, and an air intake, enabling ambient air inflow into said bulb air enclosure; a releasable first one-way valve, mounted at said air intake means, controlling air inflow from ambient air towards said bulb air enclosure; and -a releasable second one-way valve mounted at said tubular nozzle inner end portion controlling air outflow from said bulb air enclosure toward ambient air; wherein said method comprising the following steps:
a) squeezing said bulb body wall to deform same from an original larger air volume to a reduced air volume of said bulb air enclosure;
b) expelling air from said air enclosure through said air outlet means,
c) directing said expelled air toward the camera sensor to be cleaned;
d) releasing the bulb body wall;
e) allowing ambiant air to enter into said bulb air enclosure through said air intake means until said original larger air volume inside wais bulb air enclosure is substantially reached under resilient spring back action of said bulb body wall.

10. A method of a spray bulb as in claim 9, further comprising the step of providing an elongated nozzle mounted at an inner end portion thereof at said air outlet means, and having an outer end mouth at an outer end portion thereof, said elongated nozzle enabling optimal directional air expulsion from said bulb air enclosure for cleaning a target surface.

11. A method as in claim 10, further including the step of providing first air filter means, mounted into said air intake means.

12. A method as in claim 11, further including the step of providing a second air filter means mounted into said nozzle.
